(19) United States
(12) Patent Application Publication
(10) Pub. No.: US 2025/0210920 A1
(43) Pub. Date: Jun. 26, 2025

(54) SMART SOCKET DEVICE AND SYSTEM

(71) Applicant: Connected Innovations Limited, Woking Surrey (GB)

(72) Inventor: Anthony Parfitt, Leatherhead (GB)

(73) Assignee: Connected Innovations Limited, Woking Surrey (GB)

(21) Appl. No.: 18/849,871

(22) PCT Filed: Mar. 23, 2023
(86) PCT No.: PCT/GB2023/050741

§ 371 Date: Sep. 23, 2024

(30) Foreign Application Priority Data
Mar. 23, 2022 (GB) 2204105.7

(51) Int. Cl. H01R 13/713; G08B 17/06; H01R 24/78

(52) U.S. Cl. CPC H01R 13/7137; G08B 17/06; H01R 24/78

(57) ABSTRACT

A smart socket device is described which includes a socket arranged to receive an electrical plug of an electrical appliance; a mains current connector for connection to a mains current supply cable; a PCB comprising a conductor arranged such that current flows through the conductor between the mains current connector and the electrical plug during use; a thermal sensor arranged to detect the surface temperature of the conductor of the PCB; a processor in communication with the thermal sensor, the processor configured to determine when the sensed surface temperature of the conductor exceeds a predetermined threshold; and a communications link configured to communicate with a remote device. The invention also includes an electrical safety system comprising the smart socket device configured to communicate with one or more remote devices. The invention also includes a safety module for insertion into an electrical socket device and a safety module for insertion into a smart socket device.

### FIELD OF THE INVENTION

The present invention relates to a smart socket device for detecting the presence of a hazard and a system of a plurality of interconnected smart socket devices for detecting and addressing a hazard.

### BACKGROUND

Fire risks due to faulty household appliances have become an increasing concern in recent years. It has been reported that 70% of accidental house fires are caused by electrical appliances and supply. Many of these fires are due to small electrical surges or changes in ambient conditions which, if detected and addressed at an earlier stage, could be mitigated. As such, in the modern age where an increasing proportion of household devices require constant electrical connectivity, measures must be taken to ensure the safety of users and residents of households utilising such appliances.

One approach is to install in the household a sensor to detect parameters indicating the presence of a fire (such as smoke, CO, CO2 or hazardous gas). These sensors are able to sense risks of fire and sound an alarm to warn nearby residents. However, often by the time such indications are identified, a fire has already started and therefore it is too late to completely prevent damage and eliminate the danger to the occupants of a building. Furthermore such an approach is not always guaranteed to attract the attention of nearby residents, and it has been shown such a system does not dramatically reduce the occurrence of a household fire. Moreover, if the resident of the household is absent, there is often no way for a resident to know what is happening in the household, and it may be weeks before the resident actually finds out about the detected parameters and the potentially devastating effects of the fire.

As a further consideration, as urban populations increase, an increasing number of people live in multiple occupancy buildings such as purpose-built blocks of flats. Some multiple occupancy buildings may choose to employ a “waking watch” service, where staff manually patrol the building in order to detect fires and raise the alarm, if necessary. However, such services are expensive and inefficient. Furthermore, if solely a communal alarm is deployed, it can be difficult for both occupants and emergency services to locate the source of the hazard.

There is therefore a need for a system capable of detecting a potential fire risk at an earlier stage and preventing or mitigating the effects of a fire risk once detected.

### SUMMARY OF INVENTION

A smart socket according to the present invention comprises a socket arranged to receive an electrical plug of an electrical appliance; a mains current connector for connection to a mains current supply cable; a PCB comprising a conductor arranged such that current flows through the conductor between the mains current connector and the electrical plug during use; a thermal sensor arranged to detect the surface temperature of the conductor of the PCB; a processor in communication with the thermal sensor, the processor configured to determine when the sensed surface temperature of the conductor exceeds a predetermined threshold; a communications link configured to communicate with a remote device.

A “conductor of the PCB” is preferably a conductive element of the PCB within the smart socket device forming part of the conductive path of current flow between the receptacles that contact an electrical plug during use and terminals which are configured to connect the smart socket to the rest of the power network. In preferable examples, the conductor of the PCB is a portion of conductive material disposed on the PCB which is intentionally left exposed for the purpose of surface temperature measurement. This may be a planar portion of conductive material, for example, a trace on the PCB, which may be introduced into the circuit specifically for surface temperature measurement or may form part of the existing current path. In preferable examples, the conductor of the PCB may be made up of known materials and/or dimensions such that other electrical properties may be inferred from a surface temperature measurement without the requirement for additional sensors.

By detecting the surface temperature of the conductor of the PCB and identifying when the surface temperature of the conductor exceeds a predetermined threshold the smart socket device according to the present invention can identify a possible hazard at an earlier stage than conventional electrical hazard detection methods. Advantageously, by taking a measurement of the surface temperature of the conductor of the PCB rather than the plug housing or prongs, the material and geometry of the temperature measurement site is independent of any electrical appliance plugged into the socket, thereby improving the surface temperature detection accuracy and consistency.

Although the thermal sensor is configured to detect the surface temperature of the conductor of the PCB it is equally able to detect the presence of a flame.

The processor may be configured to determine when the surface temperature of the conductor of the PCB displays behaviour indicative of a potential electrical hazard. For example it may be configured to determine when temperature gradients across the surface of the conductor of the PCB exceed a certain level, when the surface temperature distribution across the conductor of the PCB displays a particular behaviour or the rate of change of the surface temperature displays a particular behaviour. The processor may use a machine learning algorithm and may be trained to identify such behaviour indicative of particular hazard. The smart socket device may additionally include a memory configured to hold data relating to surface temperature behaviour of the conductor associated with particular hazard wherein the processor is configured to receive surface temperature data of the conductor from the thermal sensor and compare this against the data stored in the memory to determine the presence of a hazard. The processor may be configured to determine the presence of hazard based on the output of the thermal sensor in combination with one or more sensors, for example a machine learning algorithm may determine the presence of a hazard based on the output of a combination of sensors, notably the temperature of the conductor detected by the thermal sensor in combination with a measured current passing through the conductor, detected by a current sensor.

Preferably the thermal sensor of the smart socket device may be configured to provide a contactless measurement of the temperature of the conductor of the PCB during use. This provides a more accurate means of identifying the temperature and avoids the need for a sensor to be accurately positioned to come into contact with the conductor of the PCB, which can result in an unsuccessful measurement should the sensor shift slightly over the lifetime of the device.

Preferably the thermal sensor is an infrared sensor. An infrared sensor may be, for example, a photon detector, a pyroelectric detector or a thermopile detector. Examples of such sensors are pyrometers and infrared thermal imaging sensors. In particular, preferably the thermal sensor is an infrared camera comprising an array of thermopile detector pixels. In this way a highly accurate reading of surface temperature can be determined so as to identify the hazard reliably. The use of thermal imaging allows for the distribution and change in temperature to be measured, allowing for more information to be gathered to provide a more reliable identification of an electrical hazard at an earlier stage.

Preferably the thermal sensor comprises a lens providing a wide field of view, for example between 30 and 90 degrees, preferably around 60 degrees.

In other examples, the thermal sensor of the smart socket device may be configured to provide a contact measurement of the temperature of the conductor of the PCB during use. Examples of such a thermal sensor include negative and temperature coefficient (NTC) thermistors, positive temperature coefficient (PTC) thermistors, resistance temperature detectors (RTDs), thermocouples and semiconductor-based sensors. In these examples. the temperature sensor may be configured to contact the surface of the conductor of the PCB to measure the surface temperature, or may be otherwise thermally coupled to the surface of the conductor of the PCB.

Preferably the conductor of the smart socket device comprises a conductive track running across a face of the PCB wherein the thermal sensor is arranged so as to be facing the conductive track. In particular, the smart socket device may comprise a first PCB, wherein the conductive track is positioned on a face of the first PCB; and a second PCB comprising the thermal sensor, wherein the first and second PCBs are arranged such that the thermal sensor of the second PCB faces the conductive track on the first PCB. More particularly, the first PCB may be arranged between the socket and the second PCB, the first PCB comprising a first face that faces the socket and a second, opposing, face that faces the second PCB, where the conductive track is positioned on the second face. This provides a compact arrangement to implement the temperature detection without substantially increasing the dimensions of the smart socket device. It also allows for retrofitting to existing smart sockets.

The conductor is preferably a planar conductor, or comprises a planar portion, positioned on a face of the (first) PCB.

Alternatively or additionally the conductor of the smart socket comprises a connector arranged to contact a pin of the electrical plug when received in the socket.

Both of the above conductor arrangements provide a fixed region of current carrying material in the interior of the smart socket device such that the thermal sensor can reliably detect the surface temperature of the conductor without being influenced by the external environment.

Preferably the socket is configured to receive a plug comprising a live pin and a neutral pin, wherein the PCB comprises: a live conductor arranged to conduct current between a live mains wire and the live pin; and a neutral conductor arranged to conduct current between a mains neutral wire and the neutral pin; wherein the thermal sensor is arranged to measure the temperature of the live conductor and/or the neutral conductor. In particular, the smart socket device may comprise a first thermal sensor arranged to measure the temperature of the live conductor and a second thermal sensor arranged to measure the temperature of the neutral conductor.

Preferably the smart socket device further comprises a housing wherein the socket is provided on a surface of the housing and the PCB and thermal sensor are positioned within the housing. This allows for the PCB and thermal sensor to be housed fully within the housing of the smart socket safety device such that it is protected.

Preferably the conductor is provided on a first PCB, the first PCB configured to provide functionality of the smart socket. In particular, preferably the first PCB comprises a relay for disconnecting the supply of mains power to an appliance plugged into the socket. Preferably the first PCB comprises a current sensor for measuring the current conducted through the conductor. Preferably the thermal sensor is provided on a second PCB arranged adjacent to the first PCB. In this way, the first PCB provides the functionality associated with a conventional smart socket and the second PCB provide the additional temperature sensing functionality of the present invention. In this way, both the first and second PCBs may be modular components and replaced and upgraded as required. Furthermore, the temperature sensing of the conductor may be retrofitted to an existing smart socket by installing the second PCB adjacent to the existing first PCB providing the smart socket functionality.

Preferably the smart socket device further comprises an ambient temperature sensor configured to measure the ambient temperature in the vicinity of the smart socket device. In particular, preferably the processor is configured to determine the predetermined threshold (or temperature change behaviour associated with an electrical fault) based on the local ambient temperature measured by the ambient temperature sensor. This allows the predetermined threshold to be adapted based on the environment the smart socket device is located in and/or the heat generated from electrical components of the smart socket device itself.

Preferably the smart socket device further comprises a relay configured to connect and disconnect the electrical plug from the mains current connector. In particular, preferably the processor is configured to control the relay in response to one or more of: receiving, via the communications link, an instruction from a remote device; the sensed surface temperature exceeding the predetermined threshold; data from a programmable timer within the smart socket device. In this way, the smart socket device can interrupt the supply of current by any one of: instruction from a remote operator, automatically if the surface temperature of the conductor reaches a level deemed to be hazardous to address the hazard, or at specified times of the day to reduce energy consumption. The instruction from a remote device may originate from a smart user device of an occupant or an emergency responder.

Preferably the smart socket device comprises one or more additional sensors, the one or more sensors comprising one or more of: a smoke and/or gas sensor; a carbon monoxide sensor; a moisture and/or water sensor; and a current sensor allowing the device to sense the presence of a greater range of hazards and identify hazards more reliably. For example, the smart socket device further comprising a current sensor may be arranged to detect the current passing through the conductor of the PCB, wherein the processor is configured to determine the presence of an electrical fault based on the combination of data received from the current sensor and data received from the thermal sensor. This allows the smart socket device to identify hazards more quickly as an increase in the surface temperature of the conductor is likely preceded by an increase in the current flowing through said conductor.

Preferably the smart socket device includes one or more of a smoke and/or gas sensor; a carbon monoxide sensor; and a current sensor; wherein the processor is configured to determine whether corresponding parameter sensed by each sensor exceeds a predetermined threshold value. A combination of sensors allows for substantially all household hazards relating to electrical equipment to be identified reliably.

Preferably the processor is configured to identify the presence of a hazard based on the output of a combination of sensors. In particular the processor uses a combination approach in which the output of a plurality of sensors is used to more reliably identify a risk. For example, the processor may employ a machine learning algorithm which uses the output of a plurality of sensors to identify a risk. In this way, a hazard can be identified more reliably than when based on the output of a single sensor. For example a combination of the output of the current sensor and thermal sensor can be used to more reliably identify the presence of an electrical fault. In particularly preferable examples, the output of the current sensor, thermal sensor and ambient temperature sensor are used to identify the presence of an electrical fault.

The smart socket device may have one, two or more sockets, each of which may have its own current sensor and relay switch.

The smart socket device is configured such that each sensed parameter has a corresponding threshold or behaviour indicative of the presence of a hazard. The device may include a memory which stores data comprising such threshold values and behaviour change patterns such that the processor can compare the sensed parameters against the corresponding data to identify the presence of a potential risk. Similarly, the processor can compare the behaviour of a combination of sensed parameters against response data stored in the memory to more reliably identify the presence of a hazard than when based on the output of a single sensor.

The smart socket device may additionally include a water sensor; wherein the smart socket device comprises a main body housing the socket, the thermal sensor and the processor; and the water sensor is arranged to be positioned on a surface below the main body of the smart socket device wherein the water sensor is connectable to the main body by a cabled or wireless connection. This allows for leaking water to also be identified which can be particularly hazardous when in combination with an electrical fault. The processor may be configured to analyse the response of the water sensor in combination with one or more other sensors to more reliably determine the presence of a hazard.

In one example the smart socket device is a plug-in adaptor unit further comprising: a plug part arranged to be received in a mains electrical socket, the plug part positioned relative to the socket such that an electrical mains plug of an electrical appliance can be received in the socket of the smart socket device when the plug part is received in a mains socket. This allows for the smart socket device to be used with existing mains sockets in a building by simply plugging the plug part of the adaptor unit into the mains socket and plugging an appliance to be monitored into the socket of the adaptor unit. The plug in adapter may comprise a single socket or a plurality of sockets thus forming an extension lead.

In another example the smart socket device is a mains socket faceplate. Preferably the main socket faceplate is configured to be mounted on a surface such as a wall to interface with the mains electrical wiring. In particular the smart socket device is a main socket fascia unit which may be installed in a building in the place of conventional mains socket units for example by screwing the device to the wall at the electrical access points. This allows for the smart socket device to be installed throughout a building to monitor all electrical appliances.

Preferably, the smart socket device further comprises an audible and/or visual alarm.

Preferably the communications link is configured to communicate with a remote device wirelessly. This allows the smart socket device to be employed in an electrical safety system (i.e. a smart socket device network) throughout a building to identify risks, alert a user and address the risks. Preferably the smart socket device is configured to communicate with other smart socket devices and/or remote devices through, including for example, a Wi-Fi network, a narrow band radio frequency network, Bluetooth, mobile telecommunication operators networks, or a mesh network communicating according to the OpenThread networking protocol. Employing more than one potential communications network provides contingency in the case of failure of one of the networks. Alternatively, or in addition to wireless communications, communication may also be performed with the use of optical or other wired communication networks, preferably ethernet or power line communication (PLC).

The smart socket device preferably further comprises means to provide an alert to a user. Preferably, the alerting means comprises an audible and/or visual alarm which may be activated to notify a user when the processor determines that the surface temperature of the conductor of the PCB exceeds a threshold value. The smart socket device preferably is also configured to send an alert to a user device such as a smart phone to notify a user of the location and type of hazard identified.

The device may also be configured to notify a voice assistant (such as Apple™ Siri, Google™ Assistant, Microsoft™ Cortana, Amazon™ Alexa) to notify a user and provide information on the hazard and directions such as a route to exit the building.

The smart socket device provides further advantages when provided in an electrical safety system including one or more smart socket devices and one or more remote devices. In this way the devices can communicate to notify a user of the risk and take action automatically or when prompted by a user to address the hazard.

In another aspect of the invention there is provided an electrical safety system comprising: the smart socket device according to the first aspect of the invention; and one or more remote devices; wherein the smart socket device is configured to send a signal to the remote device using the communications link when the processor determines that the surface temperature of the conductor of the PCB has exceeded the predetermined threshold. In this way, the remote device can either alert a user or take action to address a potential hazard.

A remote device typically includes any device connected to the network via a communications link which is not a smart socket device and may be, for example a smartphone, smart television, voice assistant device or other smart user device; a remotely controlled valve; a router or hub; a docking station for a mobile phone; a fire alarm; a smoke alarm; a sprinkler system, a dynamic illuminating sign.

Preferably, the communications link comprises a wireless communications link, wherein the wireless communications link is preferably provided by one or more of: a narrow band radio frequency network, Wi-Fi, Bluetooth, a mobile telecommunications operators network and a mesh network communicating according to the Thread (i.e. OpenThread) networking protocol. Implementing more than one network provides contingency in the case of failure of one of the networks. Alternatively, or in addition to wireless communications, communication may also be performed with the use of optical or other wired communication networks, preferably ethernet or power line communication (PLC).

Preferably, the electrical safety system further comprises one or more smart socket devices and one or more remote devices, wherein the smart socket devices and remote devices form a mesh network in which the smart socket devices and remote devices can communicate. In this way, each device can communicate with the other devices such that coordinated actions and alerts can be provided. In particular, preferably the smart socket devices and remote devices are configured to communicate according to the OpenThread networking protocol. This allows the network to operate without a single point of failure, providing redundancy to the mesh network.

The electrical safety system may include a processing unit, external to the smart socket device, that may be located locally within the same building as the smart socket device as a standalone remote device or be integrated within a remote device with multiple functions. Additionally, the processing unit may be provided as a distributed system (e.g. “Cloud” system). In some examples, the electrical safety system may comprise a local processing unit for processing the data received from the smart socket devices and remote devices and the system may further be configured to send data to a remote processing unit in the cloud, whereby the location in which processing takes place may be selected based on the particular task, the processing requirements or the current network status.

Preferably, at least one remote device of the electrical safety system comprises a smart user device and the smart user device is configured to provide an audible or visual alert after receiving a signal from the smart socket device. This allows the electrical safety system to effectively notify the user in the event of an identified hazard. Typically, a smart user device such as a smart phone or other smart device may run one or two forms of software, or “app”: (1) a user app (intended for residents), and (2) a responders app, (intended for emergency services and building authorities). The smartphone (or other smart user device) may run an app (1) or (2) with which the user can manage the system and receive alerts. In particular, when a hazard is detected a signal may be sent to the smart user device from the smart socket device and the app (1) or (2) can display information on the hazard, for example that a fire has been detected, the location of the fire and provide options for the user to limit the potential escalation of the fire, for example by shutting off an electrical supply or calling emergency services. Furthermore, if a smart user device of the responder has locationing capabilities, the substantially real time location of the responder may be provided to other to smart user devices running the user app (1).

Data may be transmitted from each smart socket device and remote device either directly or indirectly through other processing nodes, for example via a data communication interface, preferably a cellular network modem (and/or SIM card) integrated in each device for direct communication with the processing unit over the internet. More typically, a smart socket device or remote device may be in communication with a node (“hub”) within a local network, wherein the hub may communicate the data to the processing unit over an external network such as the internet.

The processing unit may be communicatively coupled to a memory, which may be a “Cloud” memory, storing, for example, information about the devices within the electrical safety system, the location of smart socket devices within the electrical safety system and the layout of the building in which the local devices of the electrical safety system are located. The building layout data may comprise a pre-generated 3D map of locations within said building. Alternatively, the layout of said building may be generated based on the locations of smart socket devices in a mesh network within the building. The building layout data can be accessed for purposes of evacuation by the evacuees and for purposes of emergency response by the emergency services, for example, via the app (1) or (2) on a smart user device. This data is typically stored in the cloud and accessed using appropriate user authority and identity management. This data can also be provided to, for example, local hospitals in order to notify and prepare them for an influx of possible emergency hospital admissions.

Preferably at least one remote device comprises a voice assistant device (such as Apple™ Siri, Google™ Assistant, Microsoft™ Cortana, Amazon™ Alexa) where the voice assistant device is configured to notify a user upon receiving a signal from the smart socket device. The voice assistant device may be configured to provide one or more of: information on the type and location of the hazard, provide options for responding (e.g. call emergency services, activate an isolation device) or information on how to safely exit the building to avoid the hazard.

Preferably at least one remote device comprises dynamic signage comprising a configurable display, wherein the dynamic sign is configured to receive a signal from a smart socket and display information on the configurable display in response to receiving a signal from the smart socket device. The dynamic sign preferably comprises a matrix of LEDs such that the information displayed by said sign is programmable. The system is preferably configured to display instructions on the dynamic signage to coordinate an evacuation in the event of an emergency. In particular the dynamic signage is configured to display directions for evacuation, instructions and/or incident updates.

Preferably at least one remote device comprises a speaker configured to sound an alarm or provide an audible announcement in response to receiving a signal from the smart socket device.

Preferably, at least one remote device comprises a computer system of a fire department. In response to receiving a signal from the smart socket device, the fire department may be provided with information about the status of the identified hazard. This may enable, for example, emergency responders to arrive at the scene faster and with more information in the event that the hazard develops into a fire.

Preferably, at least one remote device comprises a firefighter's helmet comprising an integrated visor providing augmented reality capabilities and additionally comprising a battery pack and a communications link. In particular, in response to receiving a signal from the smart socket device, the augmented reality visor may provide the wearer with information about the current status of the hazard identified by the smart socket device, a 3D map of the building in which the smart socket device is located indicating where the hazard is located and digital markers/symbols providing information to the wearer.

Preferably, at least one remote device of the electrical safety system comprises an isolation unit comprising a communications link; wherein the isolation unit is configured to restrict a flow of water, gas or electricity through the isolation unit upon receiving a signal from the smart socket device. In this way, an isolation unit can receive a communication from a smart socket device that an appliance is exhibiting behaviour indicative of a fault and the isolation device can take action to restrict or prevent the flow of services to that specific appliance, to a part of the building or to the building as a whole.

Wherein at least one remote device comprises a smart user device, the smart user device is preferably configured to send a signal to the isolation unit to remotely control the isolation unit after receiving a signal from a smart socket device. This may be performed via the app (1) by a resident of the building or via the app (2) by an emergency responder.

The isolation units may take several different forms. In one example, at least one isolation unit comprises a local water isolation unit arranged for installation at the local water connection to an electrical appliance; the local water isolation unit comprising: a cabled or wireless connection for connecting to the smart socket device; and a motorised valve; wherein the local water isolation unit is configured to close the motorised valve to restrict the water supply to the electrical appliance upon receiving a signal from the smart socket device. In this way, the water supply to a particular appliance, group of appliances or region of a building can be restricted to prevent flooding or an electrical fault being spread by water.

Preferably at least one isolation unit comprises a mains supply isolation unit comprising: at least one motorised valve arranged for installation in a mains water feed, a header water tank or mains gas supply; wherein the mains supply isolation unit is configured to close the motorised valve to restrict the mains supply upon receiving a signal from the smart socket device. Preferably at least one isolation unit comprises a mains electrical isolation unit comprising: a mains electrical shut off switch; wherein the electrical isolation unit is configured to actuate the electrical shut off switch to shut off the mains electricity upon receiving a signal from the smart socket device. Using these mains isolation units the further supply of gas, electricity or water throughout the building or to a specific zone in a building can be stopped to prevent a hazard escalating.

The main electrical isolation unit may be connected to a mains consumer unit and is configured to actuate a main switch on the mains consumer unit to shut off the main electricity supply. Alternatively the mains electrical isolation unit may be integrated within the consumer unit or fuse box.

The isolation unit may include one or more local sensors to identify a local hazard. Preferably the isolation unit comprises a processor and one or more of: a thermal sensor; a smoke and/or gas sensor; a carbon monoxide sensor; a moisture and/or water sensor; a current sensor; wherein the isolation unit is configured restrict a flow of water, gas or electricity when the processor determines that a parameter sensed by a local sensor exceeds a predetermined threshold.

When connected together via a mesh network, the smart socket devices and isolation units making up an electrical safety system are preferably each assigned to a group wherein a number of said smart socket devices and isolation units make up each group. The grouping may be based on, for example, the location of the devices, particularly in the case of an electrical safety system deployed across a multi-occupancy building. For example, an electrical safety system may comprise a plurality of smart socket devices located across a number of flats within a building and a plurality of mains supply isolation units configured to restrict a mains supply of each flat in the building. The smart socket devices may be grouped based on which flat they are located in and the isolation units may be grouped based on which flat's mains supplies they may restrict. If a first smart socket device located in a first flat determines that the sensed surface temperature of the conductor exceeds a predetermined threshold, said first smart socket device may use the grouping to identify which other smart socket devices are located within said first flat and optionally within neighbouring flats. Furthermore, the first smart socket device may also use the grouping to identify the one or more isolation units that can restrict the mains supplies of the first flat and optionally neighbouring flats.

The first smart socket device may then automatically send a signal to the other identified smart socket devices and isolation units to, for example, disconnect the sockets of the smart socket devices via provided relays and/or restrict the mains supplies of one or more of gas water and electricity. This action may be performed automatically either simultaneously or in sequence (for example by distance from the first smart socket device) or manually.

Preferably, when connected together via a mesh network, the smart socket devices making up an electrical safety system may be used in combination with one or more of the processing unit and memory of the electrical safety system to identify the locations of any escalated hazards such as fires within a building and provide a three dimensional (3D) mapping of the layout of the building showing the location of hazards to occupants and or emergency responders via a smart user device or the firefighter's helmet described above. For example, if a first smart socket device located in a first flat of a multi-occupancy building determines that the sensed surface temperature of the conductor exceeds a predetermined threshold, said first smart socket device may send a signal to the processing unit of the electrical safety system. The processing unit may then analyse the data sent by the first smart socket to determine the location of the hazard (e.g. in which flat is the hazard). The processing unit may then recall a layout of the building in which the local devices of the electrical safety system are located from a communicatively coupled memory and may then use the hazard location and building layout to generate a 3D map of the building indicating a location of the hazard. Alternatively, a 3D map of the layout of said building may be generated based on the locations of smart socket devices in a mesh network within the building. In the event of an escalated hazard such as a fire, this mapping allows emergency services to act more efficiently when they arrive on the scene and occupants can evacuate safely.

Optionally, the electrical safety system may comprise further standalone sensors such as a thermal sensor or module comprising multiple thermal sensors, a smoke sensor, a gas sensor, a carbon monoxide sensor and a water sensor, each comprising a communications link. The electrical safety system may further comprise an electrical appliance with an integrated thermal sensor. The electrical safety system may further comprise additional safety devices such as a plug in adapter, a light switch faceplate and a wall/ceiling mounted sensing unit, wherein each of said safety device comprises at least a thermal sensor. Further detail on the abovementioned safety devices may be found in United Kingdom Patent Application No. 2015243.5.

In another aspect of the invention there is provided a safety module for insertion into an electrical socket device, the electrical socket device comprising a socket arranged to receive an electrical plug of an electrical appliance and a mains current connector for connection to a mains current supply cable, the safety module comprising: a PCB comprising a conductor arranged such that current flows through the conductor between the mains current connector to the electrical plug during use; a thermal sensor arranged to detect the surface temperature of the conductor of the PCB; a processor in communication with the thermal sensor, the processor configured to determine when the sensed surface temperature of the conductor exceeds a predetermined threshold; a communications link configured to communicate with a remote device. In this way the safety module may be retrofitted into a conventional socket to provide hazard detection via providing a first PCB with a conductor, through which the current from the mains to the appliance is routed, and a second PCB with thermal sensors for temperature measurement of the conductor provided on the first PCB. The safety module may provide additional functionality, as described above under the first aspect of the invention.

In a further aspect of the invention there is provided a safety module for insertion into a conventional smart socket device, the smart socket device comprising a socket arranged to receive an electrical plug of an electrical appliance, a mains current connector for connection to a mains current supply cable and a PCB comprising a conductor arranged such that current flows through the conductor between the mains current connector to the electrical plug during use, the safety module comprising: a thermal sensor arranged to detect the surface temperature of the conductor of the PCB of the smart socket; a processor in communication with the thermal sensor, the processor configured to determine when the sensed surface temperature of the conductor exceeds a predetermined threshold. In this way the safety module may be retrofitted into a conventional smart socket device to provide hazard detection via measuring the temperature of a conductor present on the PCB of the smart socket. Preferably the safety module comprises a PCB on which the thermal sensors are provided, wherein the safety module is configured to be arranged such that the PCB of the safety module is adjacent the PCB of the smart socket. The safety module may provide additional functionality, as described above under the first aspect of the invention.

All of the functionality described above with respect to the smart socket device can also be implemented in the above safety modules. A safety module, once inserted into an electrical socket device or smart socket device, may herein be referred to as a smart socket device according to the present invention and may form part of the electrical safety system described above.

In this way, a user may adapt a conventional electrical socket device or smart socket device into a smart socket device according to the present invention by retrofitting a safety module within the housing of said electrical socket device or smart socket device. This allows for convenient integration of safety features in locations wherein conventional sockets are already provided without the need to completely replace the conventional sockets.

In a further aspect of the invention there is provided a firefighter's helmet comprising an integrated visor providing augmented reality capabilities, a battery pack and a communications link. Preferably the communications link is configured to receive a signal from a smart socket device as defined above and the integrated visor is configured to display information in response to the signal received.

### BRIEF DESCRIPTION OF DRAWINGS

Embodiments of the invention will now be described, by way of example only, with reference to the accompanying drawings, in which:

FIGS. 1A-1C schematically illustrate a smart socket device according to the present invention in the form of either a mains socket faceplate or safety module inserted into a conventional electrical socket device;

FIGS. 2A-2C schematically illustrate a smart socket device according to the present invention in the form of either a mains socket faceplate or safety module inserted into a conventional electrical socket device;

FIG. 3A schematically illustrates a smart socket device according to the present invention in the form of safety module inserted into a conventional smart socket device;

FIGS. 3B and 3C schematically illustrate PCBs of a safety module for insertion into a conventional smart socket device according to the present invention;

FIG. 4 schematically illustrates a remote device of an electrical safety system according to the present invention comprising a firefighter's helmet.

FIG. 5 schematically illustrates an electrical safety system according to the present invention.

### DETAILED DESCRIPTION

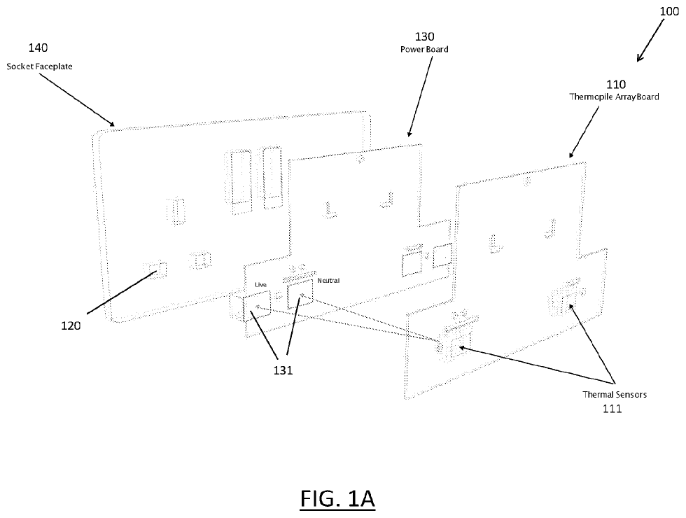

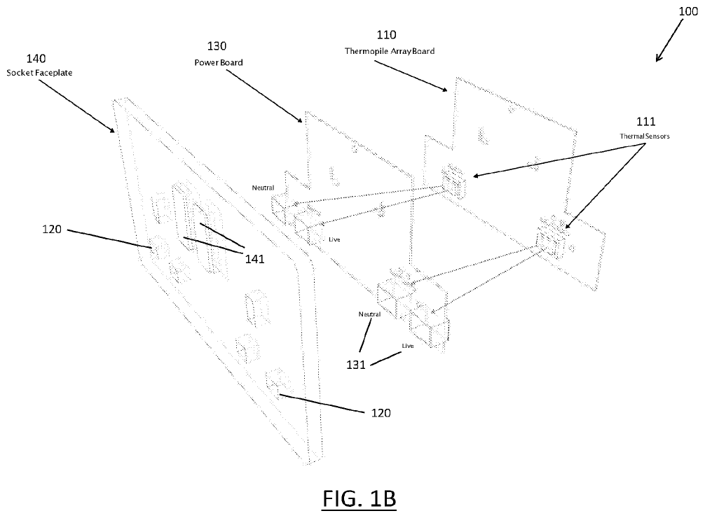

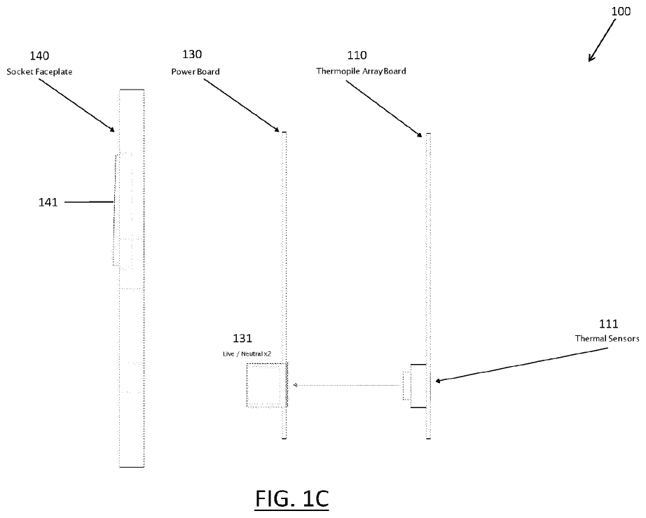

FIGS. 1A-1C illustrate a smart socket device 100 according to the present invention. The smart socket device 100 includes a socket 120 positioned behind a socket faceplate 140 and arranged to receive an electrical plug of an electrical appliance, a mains current connector (not shown) for connection to a mains current supply cable, and a first PCB 130 comprising live and neutral conductors 131 arranged such that current is able to flow through the conductors 131 between the mains current connector to the electrical plug during use. The smart socket device 100 further includes a second PCB 110 comprising thermal sensors 111, mounted on the second PCB 110, arranged to detect the surface temperature of an electrical plug when it is received in the socket 120 of the smart socket device 100.

The smart socket device 100 further includes a processor (internal to the device and not pictured) which is in communication with the thermal sensors 111 and is configured to determine when the sensed surface temperature of the conductor 131 of the PCB 130 exceeds a predetermined threshold and/or displays a particular variation pattern associated with the risk of an electrical fault. Since the thermal sensor 110 is arranged to detect the surface temperature of the conductor 131 of the PCB 130, the smart socket device 100 allows for early detection of hazardous conditions which could result in a fire. In particular, a primary cause of house fires is the overheating due to an electrical fault in an electrical appliance. Such electrical faults can be determined at a very early stage by an increased in surface temperature of the conductor 131 of the PCB 130 such that, by monitoring this parameter, electrical faults can be detected within the smart socket device before they escalate.

The smart socket device 100 further includes a communications link configured to communicate with a remote device. Said communications link preferably provides wireless communication functionality in order to send alerts to a user device such as a smartphone and to take various actions to mitigate the risk, including switching off the mains electricity, water or gas supply by communication with one or more remote devices. As will be described in more detail below, a plurality of smart socket devices and remote devices may be connected together within a network to facilitate a range of functionality to identify a potential hazard at an early stage, alert a user and the emergency services and take a range of measures to address the hazard-either autonomously or when instructed by a user through a connected smart user device.

The smart socket device 100 may further comprise a range of functionality to provide various responses when the processor determines that the sensed surface temperature of the conductor 131 of the PCB 130 exceeds the predetermined threshold. In particular, the device 100 may further include an internal alarm sounder to provide an alert when the surface temperature of the conductor of the PCB exceeds the predetermined threshold, therefore indicating a risk of fire. The device 100 may include one or more relay switches for stopping current flow to an appliance through the smart socket device 100. Furthermore, the smart socket device 100 may comprise a number of additional sensors to detect the presence of a hazard.

The smart socket device 100 may provide a range of functionality associated with commercially available smart sockets. For example, the first PCB 130 may include a relay to allow for remote control of the smart socket, allowing the current supply to an appliance plugged into the socket to be turned off and on remotely by a user operating a connected user device—or via a programmable timer. The first PCB 130, also referred to as the “power board”, may additionally comprise a sensor for measuring the power supplied to an appliance plugged into the smart socket device 100, for example a current sensor provided on the first PCB 130. In order to provide this functionality, conventional smart sockets include a PCB with some form of conductor through which the mains current supply is connected to an appliance plugged into the socket. The present invention utilises this conductor as a means of also detecting the presence of an electrical fault in an appliance plugged into the smart socket. In particular, the inventors have identified that an electrical fault in an appliance is recognisable at an early stage through an increase in temperature of the conductor on the PCB of a smart socket and so appropriately configured thermal sensors are able to identify a potential hazard at an early stage.

### Conductor of the PCB

As described above, the conductors 131 of the first PCB 130 of the smart socket device 100 are arranged such that current flows through the conductors between the mains current connector to the electrical plug during use. In the example illustrated in FIGS. 1A-1C, the conductors 131 are spring connectors arranged to maintain contact with a pin of the electrical plug when received in the socket via the restoring force of said spring connector. Similarly, other electrical connectors such as spade connectors, ring connectors, bullet connectors and screw terminals may be provided as conductors 131 of the PCB 130. The conductors 131 may be composed of metals with a high electrical conductivity such as alloys of silver, copper, gold, platinum, and palladium.

The conductors 131 generally comprise a planar portion of the conductor positioned on a planar face of the PCB 130. In particular, the first PCB 130 is arranged such that a first face of the PCB is adjacent to the underside of the socket faceplate 140 and a second face of the PCB, opposite to the first face, faces away from the faceplate 140. The conductors 131 comprise a planar portion of electrically conductive material on the second face of the PCB 130, providing a region at which the thermal sensors 111 may be directed. In this way, a compact and effective arrangement can be achieved by providing the second PCB 110 (the “thermopile array board”) substantially parallel with the first PCB 130 with the thermal sensors 111 arranged so as to face the planar portion of the conductors 131 on the second face of the first PCB 130. In the example of FIG. 1A-1C the conductor 131 comprises a spring connector arranged to receive the pins of an electrical plug and a planar portion on the second face of the PCB 130.

Although FIGS. 1A-1C illustrate a pair of conductors 131, one for each of the live and neutral current paths, a single conductor 131 of either the live or neutral current path may be exposed on a face of PCB 130, or a trio of conductors 131, one for each of the live, neutral and earth current paths may be exposed on a face of PCB 130. Each provided conductor is arranged to make electrical contact with the corresponding live, neutral or earth prongs of an electrical plug when plugged into the socket 120.

Thermal sensor 111 may detect the surface temperature of one or more of the provided conductors 131 connected to a socket 120, or alternatively, multiple thermal sensors per socket 120 111 may be provided, each configured to detect the surface temperature of an individual conductor 131 where multiple are exposed on a face of PCB 130.

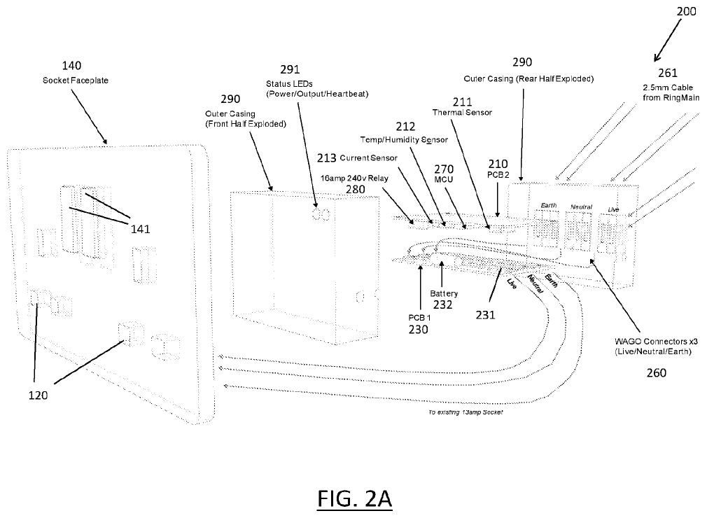

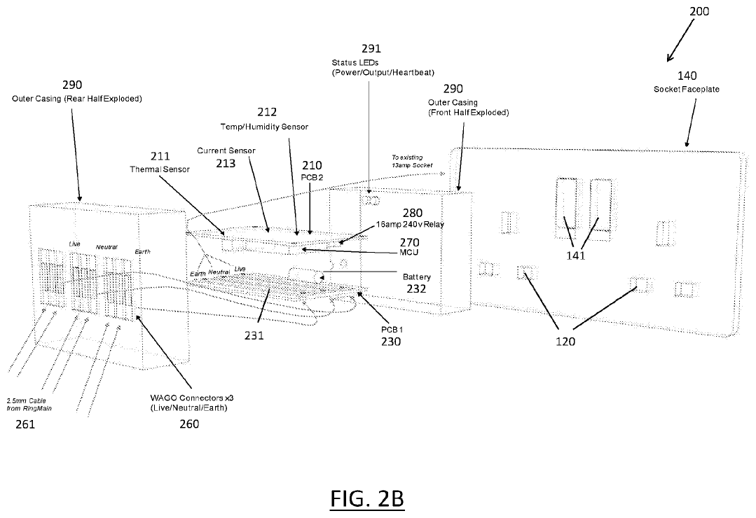

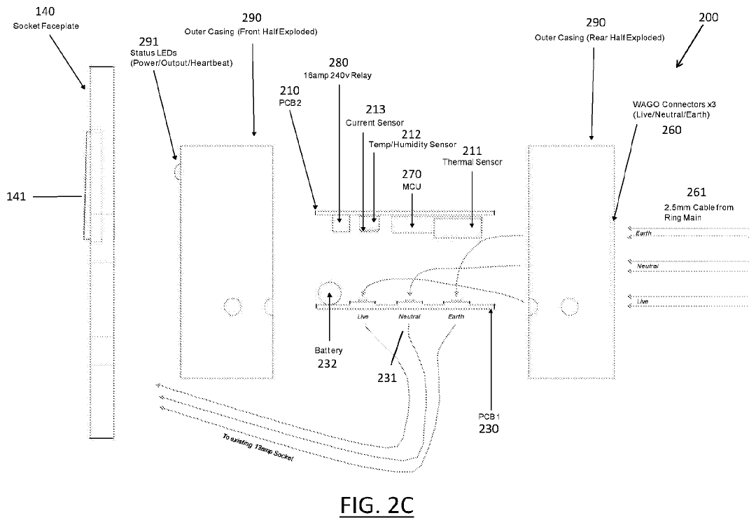

An alternative arrangement of the conductor of the PCB is illustrated in FIGS. 2A-2C. The conductors 231 of smart socket device 200 are conductive tracks running across a face of the PCB 230 and may be composed of metals with a high electrical conductivity such as the examples provided above. In FIGS. 2A-2C, a trio of conductive tracks are shown running across the face of PCB 230, each track forming part of one of the live, neutral and earth current paths. Alternatively, a single or pair of tracks may be provided on the face of the PCB 230 wherein each track forms part of one of the live, neutral or earth current paths.

The surface temperature of the provided conductors 231 may be measured by thermal sensor 211, or alternatively multiple thermal sensors 211 may be provided, each configured to detect the surface temperature of an individual conductive tracks 231 wherein multiple are exposed on a face of the PCB 230.

As shown in FIGS. 2A-2C, the PCB 210 comprising the thermal sensor 211 and the PCB 230 comprising the conductive tracks 231 are positioned relative to each other such that the conductive tracks 231 are within the field of view of the thermal sensor 211. Although FIGS. 2A-2C show the conductive tracks 231 positioned on the upwards pointing face of PCB 230 and the thermal sensor 211 positioned on the downwards pointing face of the PCB 210, the PCBs may be provided in any suitable orientation wherein the PCB 210 and the PCB 230 are arranged such that the thermal sensor of the PCB 210 faces the conductive track on the PCB 230 such that the conductive tracks are within the field of view of the thermal sensor 211.

The conductors described above are confined wholly within the interior of the smart socket device such that no live surfaces are externally exposed when the smart socket device is in use.

Furthermore, both arrangements ensure that the material and geometry of the temperature measurement surface remains constant independent of the plugged in electrical appliance. This may improve the accuracy and consistency of surface temperature detection. For example, if the material of the conductive tracks 231 is known, pertinent physical properties of the conductive material such as its emissivity may be used by the processor to calibrate the thermal sensor 211 to provide a more accurate surface temperature detection.

### Thermal Sensor

The thermal sensor 111 is provided by an infrared sensor configured to detect absolute temperature by measuring the emitted infrared radiation. The calculated temperature is then based on a known or assumed emissivity of the target surface.

The thermal sensor 111 may be, for example, a pyrometer configured to detect the absolute temperature of a point on the surface of the conductor 131 of the PCB 130 or alternatively, the thermal sensor 111 may be an infrared camera comprising an array of infrared detector pixels. The infrared array sensor may comprise an 8×8 grid array of thermopile elements that detect absolute temperature by measuring the emitted infrared radiation. This infrared array sensor is able to provide thermal images by measuring actual temperature and temperature gradients, allowing highly precise measurements of surface temperature and identification of changes in temperature. The infrared array sensor preferably also includes a lens to provide an increased viewing angle such that a large area of the conductor can be imaged even when the thermal sensor 111 is positioned a short distance away. The lens may comprise an integral silicon lens which provides a viewing angle of around 60 degrees. The thermal sensor 111 is preferably configured to detect temperature changes over a range of −20° C. to 100° C., allowing for tracking of the surface temperature of the conductor 131 of the PCB 130 as it begins to heat up in the case of an electrical fault. The thermal sensor 111 may be for example a Panasonic grid-EYE® sensor, generally used for movement detection, occupancy detection, people counting and lighting control.

The thermal sensor 111 is arranged to provide a contactless temperature measurement of the surface of the conductor 131 of the PCB 130 when an electrical appliance is connected to the socket 120. The use of contactless thermal imaging allows for imaging of the conductor 131 as a whole, allowing for temperature changes to be detected across the conductor rather than from a single point as necessitated by a contact measurement. Furthermore, a contact measurement requires that a contact temperature sensor is provided so as to remain in contact with the conductor 131. If the contact temperature sensor is dislodged out of place such that it is no longer in contact with the conductor, it will no longer provide an accurate temperature measurement such that there is a risk that a hazardous fault in the electrical appliance will not be detected. An infrared array sensor also provides for the possibility of more complex processing carried out on the thermal image received by the sensor. For example, more advanced machine learning based algorithms can be used to detect temperature change patterns which are indicative of a high risk fault in the appliance.

The thermal sensor 111 may be positioned in a number of different ways to achieve the reading of surface temperature of the conductor 131 of the PCB 130. In FIGS. 1A-1C the thermal sensor 111 is located on a second PCB 110 positioned behind the PCB 130 when the smart socket device 100 is viewed from the socket faceplate 140. In particular, the thermal sensor 111 is positioned in a location on the PCB 110 such that the conductor 131 of the PCB 130 is within the field of view of the thermal sensor 111. Such that the thermal sensor 111 images the surface of the conductor 131 of the PCB 130. The thermal sensor 111 may equally be placed in a number of alternative locations so as to provide a contactless surface temperature measurement of the conductor 130 of the PCB 130 of the smart socket device 100.

In other non-illustrated examples, the thermal sensor 111 may alternatively be be configured to provide a contact measurement of the temperature of the conductor 131 of the PCB 130 during use. Examples of such a thermal sensor include negative and temperature coefficient (NTC) thermistors, positive temperature coefficient (PTC) thermistors, resistance temperature detectors (RTDs), thermocouples and semiconductor-based sensors. In these examples. the temperature sensor 111 may be configured to contact the surface of the conductor 131 of the PCB 130 to measure the surface temperature, or may be otherwise thermally coupled to the surface of the conductor 131 of the PCB 130.

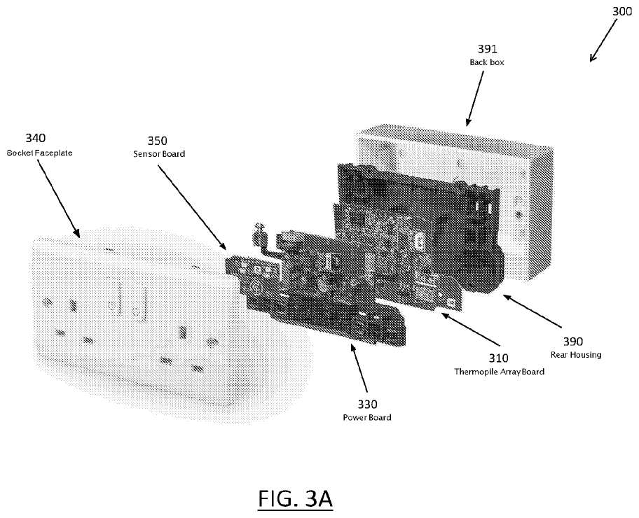

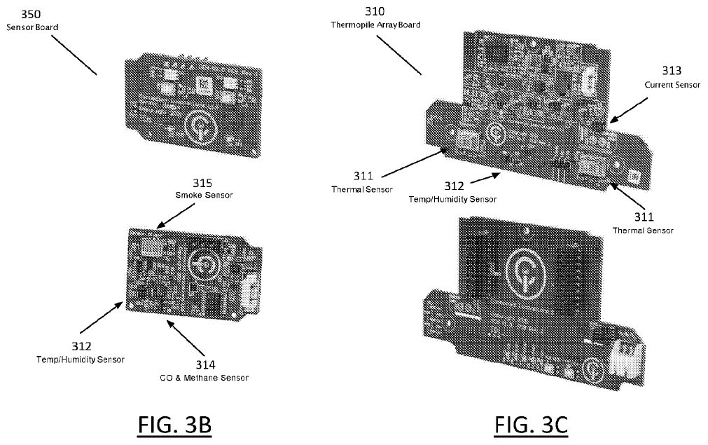

The above description of thermal sensor 111 may equally apply to thermal sensor 211 in FIGS. 2A-2C and thermal sensor 311 in FIGS. 3B and 3C.

### Mains Socket Faceplate

The smart socket device 100 shown in FIGS. 1A-1C may be provided as a mains socket faceplate, which is a mains socket fascia unit configured to be mounted at an electrical connection point on a wall or other surface. The mains socket fascia of FIGS. 1A-1C comprises a substantially flat body defined by a socket faceplate 140, as in a conventional mains socket fascia. The smart socket device 100 is configured to be positioned in place of a conventional main socket fascia at the electrical access points in a building to provide enhanced safety against the risk of fires and electrical faults. In the example of FIGS. 1A-1C, the smart socket device 100 comprises two sockets 120, but other such smart socket devices could equally have a single socket 120 or a greater number of sockets 120. Similarly, although the device 100 of FIGS. 1A-1C is in the form of a face plate configured to be attached to a wall or other surface, it might equally be provided as a moveable extension socket configured to be attached via a cable to a mains socket. The smart socket device faceplate 140 includes switches 141 to switch on the current supply to the corresponding socket 120, as in a conventional mains socket faceplate. In use, the smart socket device faceplate 140 is attached to a wall by screwing it into place using screws (not shown), in place of a conventional main socket faceplate. An electrical appliance is plugged into a socket 120 and current supplied by switching switch 141 to the on position.

In device 100, the surface temperature of the conductor 131 of the PCB 130 is monitored by the thermal infrared sensor 111. When a specific temperature or change in temperature is identified by the processor (not shown), the device 100 determines the presence of a possible risk and can take a number of actions. The smart socket device 100 firstly may comprise an internal alarm sounder (not shown) which is configured to sound when a hazard is detected in order to alert the occupants in the surrounding area.

Furthermore, the smart socket device 100 comprises a communications link configured to communicate with one or more remote devices. In particular, the device 100 is configured to communicate wirelessly via the communications link to a user device such as a smartphone in order to alert a user of the presence of a potential electrical fault and provide further information regarding the type of hazard detected and its position within the building.

The smart socket device 100 may include a reset switch (not shown) for resetting the device 100 or silencing the alarm when it is sounding. The smart socket device 100 may further comprise a series of status LEDs to indicate to a user that the device 100 is functioning correctly. In particular the LEDs may indicate the status for the network connectivity, the power to the device and the sounding of the alarm. The series of LEDs may be provided on the surface of the housing 130 to provide visual alert to the user. The smart socket device 100 may equally be configured to communicate via the wireless communications link with other user devices such as a smart TV, smart watch or other devices to indicate the presence of a potential hazard and provide details on the hazard detected.

The smart socket device 200 shown in FIGS. 2A-2C may equivalently be provided as a mains socket fascia and may include any of the features of smart socket 100 described above. The housing of smart socket device 200 comprises socket faceplate 140 and an outer casing 290 which is configured to contain the PCB 230 and the PCB 210. The front half of the outer casing 290 includes status LEDs 291 configured to perform the function as described above in relation to smart socket device 100. The rear half of the outer casing comprises a mains current connector 260 for connection to the mains cable 261. Preferably, the mains current connector 260 comprises one or more solderless terminals for each of the live, neutral and earth cables 261. As shown in FIGS. 2A-2C, the mains current connector 260 may comprise a 3-way WAGO connector for each of the live, neutral and earth mains cables 261 allowing for integration into a ring circuit and optional connection to a spur socket.

As described above, the conductor 231 of the PCB 230 comprises a conductive track running across a face of the PCB 230. The PCB 230 further comprises a battery 232 such that in the event of a power outage or a hazardous situation where the mains electrical supply has been purposefully shut down, the battery can power any provided sensors, the processor 270 and the communications link such that the smart socket device can continue to communicate with a remote device.

The PCB 210 further includes a processor 270 and a relay 280 arranged to selectively control the current between the plug part and the socket. In the event that one of the on-board sensors detects a parameter which indicates a potential hazard and/or fire such as the sensed surface temperature of the conductor 231 exceeding the predetermined threshold, the device 200 automatically actuates the relay 280 such that the electrical connection between the electrical appliance and the socket is interrupted. This ensures that, when a potential hazard is perceived by the adapter, electrical power supply to the potentially hazardous appliance is immediately switched off. Additionally, the relay 280 may be actuated by receiving, via the communications link, an instruction from a remote device or based on data from a programmable timer within the smart socket device.

As with the smart socket device 100, the smart socket device 200 may comprise an internal alarm sounder (not shown) which is configured to sound when a hazard is detected in order to alert the occupants in the surrounding area. The smart socket device 200 may also include a reset switch (not shown) for resetting the device 200 or silencing the alarm when it is sounding.

### Additional Sensors

In addition to the thermal sensor 110, the smart socket device 100 may comprise a number of additional sensors to detect the presence of a hazard. Equivalently, the smart socket device 200 may also further comprise a number of sensors in addition to those illustrated in the example provided in FIGS. 2A-2C.

Below, a range of additional sensors are described in relation to smart socket device 200, however, said additional sensors may equally be implemented in other examples of the smart socket device such as the smart socket device 100 or a safety module for insertion into an electrical socket device.

The exemplary smart socket device 200 of FIGS. 2A-2C further comprises an ambient temperature and/or humidity sensor 212 that may be used to determine the predetermined threshold surface temperature (or temperature change behaviour associated with an electrical fault) of the conductors 231 of the PCB 230 based on the measured local ambient temperature, and a current sensor 213 for monitoring the current supplied to an electrical appliance plugged into the smart socket device 200. The current sensor is positioned within the device to measure current flowing to one or more electrical appliances plugged into the smart socket device 200. The smart socket device 200 may further comprise: one or more of a smoke and/or gas sensor configured to detect smoke from any electrical device connected to the smart socket device 200 or smoke and/or gas, preferably methane, in the vicinity of the device 200, for example from gas fires, boilers or cookers; and a carbon monoxide sensor configured to detect carbon monoxide in the vicinity of the smart socket device 200, for example from gas fires or boilers.

Each of the sensors are electrically connected to the processor 270 within the device 200 such that the processor 270 can calculate whether any of the sensed parameters are indicative of a potential hazard. The processor 270 is configured to determine the presence of a potential hazard by identifying when the value of a sensed parameter exceeds a predetermined threshold value. However more complex processing may be used to identify the presence of a hazard, for example by identifying a rate of change of a sensed parameter or where a sensed parameter change displays a particular behaviour or pattern associated with an increased risk of a hazard. The processor 270 can also be configured to determine the presence of a hazard based on a combination of sensor outputs in order to identify a risk more reliably. For example the processor 270 can use more complex algorithms, such as machine learning based algorithms which take the output from multiple sensors in order to determine an elevate risk. For example in a situation where the current sensor and thermal sensor readings are lower than their corresponding individual thresholds, the behaviour of the sensor readings in combination may signify a developing hazard and therefore this can be detected at an earlier stage than with a single sensor. Similarly an unusual rate of chance of one or more parameters may indicate the presence of a hazard. The device 200 may include an internal memory holding such sensor parameter data with the processor 270 configured to compare the received data with data indicative of a hazard held in the memory in order to identify the presence of a hazard. The processor 270 may use more complex algorithms such as machine learning algorithms which can be trained to identify changes in the parameters associated with increased risks of a potential hazard. For example, the machine learning algorithm may include a neural network (or support vector machine) which functions to receive he data from the sensors as inputs and, once trained on a set of simulated hazards, may be able to identify a real-life hazard from a combination of inputs from the sensors using weights and thresholds that may not be set of predetermined by the operator. In another example, a linear regression model may be used to identify changes of parameters over time to predict or estimate a level of risk.

The smart socket device 200 can also include a water sensor (not shown) arranged to detect the presence of water in the vicinity of the device 200. In particular the water sensor may comprise a water sensor body arranged to lie on the ground below the smart socket device 200 so as to detect collecting water on a surface below the device 200. The water sensor body is connected to the device by a water sensor connection. The connection may comprise a plug which plugs into a corresponding socket on the side of the device to connect the water sensor to the internal processor 270 such that the processor 270 can receive signals from the water sensor to identify the presence of water and alert a user using the alarm or wireless communications link to a user device. The presence of water may be particularly hazardous when there is an electrical fault with the appliance and the additional water sensor can detect the presence of a leak from a household appliance or mains water in order to identify such a hazard.

In addition to providing an alarm or sending an alert to a remote device such as a smartphone, the smart socket device 200 can also take actions automatically, or when prompted by a user, to respond to the detected hazards. In this way, the smart socket device 200 forms part of an electrical safety system which can detect a hazard, alert a user and take appropriate action to address the hazard.

### Safety Module

Although FIGS. 1A-1C and 2A-2C were described above as illustrating examples of a smart socket device, they may equivalently illustrate exemplary embodiments of a safety module for insertion into an electrical socket device in accordance with the present invention shown in combination with an electrical socket device. The safety module may be configured for insertion into a conventional electrical socket, or for insertion into a smart socket to provide hazard detection via measurement of a conductor on a PCB. The safety module, when inserted into a conventional electrical socket device, may provide the same functionality as a smart socket device according to the present invention and therefore the device resulting from retrofitting a safety module to an electrical socket device may also be referred to herein as a smart socket device. The process of inserting such a safety module into an existing electrical socket device may herein be referred to as retrofitting the safety module to an electrical socket device.

Referring to FIGS. 1A-1C, in one example, the safety module comprises PCB 110 along with any components located thereon and is configured for insertion into a conventional smart socket device, in which the first PCB (the power board) 130 is already present. Therefore in this example, the electrical socket device may provide, for example, the socket faceplate 140, the PCB 130 (used to provide conventional smart socket functionality) and an optional back box (not shown). The safety module is retrofitted to the electrical smart socket device wherein the PCB 110 is arranged such that the live and neutral conductors 131 of each socket of the electrical socket device (shown on PCB 130 present in the smart socket) are within the field of view of the thermal sensor 111.

In other examples, the safety module may be configured for insertion into a conventional (non-smart) socket, which does not include a PCB 130 to provide functionality such as on/off switching via a relay and current monitoring. In these examples, the safety module comprises both the first PCB (power board) 130, including conductors for conducting mains power to an appliance when connected, and the second PCB (thermal sensor board) 110, including the thermal sensors for detecting the temperature of the conductors 131 of the first PCB.

Referring to FIGS. 2A-2C, in another example, the safety module comprises the outer casing 290 and any components on or within the outer casing 290. Again, the electrical socket device may provide, for example, the socket faceplate 140 and an optional back box (not shown). In this example, the existing mains supply cables from the conventional electrical socket device may be disconnected from the socket faceplate and reconnected to the mains current connector 260 on the rear half of outer casing 290. Cables are then connected between the conductor tracks 231 and sockets 120 of the socket faceplate 140 to reconnect the sockets 120 to the mains supply.

FIG. 3A illustrates an exemplary smart socket device according to the present invention 300 wherein a safety module according to the invention has been retrofitted to a smart socket device. In this example, the safety module comprises PCB 310 and PCB 350 and the smart socket device comprises socket faceplate 340, PCB 330, rear housing 390 and back box 391. In this example, the existing socket already implements some ‘smart’ features such as providing, on PCB 330, relays configured to connect and disconnect the electrical sockets, a processor and a communications link such that said relays can be controlled from a remote device such as a smartphone. By retrofitting PCB 310 and PCB 350 to a conventional smart socket device, the resulting device is able to sense the presence of a greater range of hazards and identify certain hazards more reliably.

FIG. 3B illustrates PCB 350 in more detail. PCB 350 includes a temperature and/or humidity sensor 312, a carbon monoxide and/or methane gas sensor 314 and a smoke sensor 315. PCB 310 shown in FIG. 3C includes thermal sensors 311, a temperature/humidity sensor 312 and a current sensor 313 and a processor (not shown) configured to receive data from the provided sensors. The sensors located on PCB 350 may be communicatively coupled to the PCB 310 via one or more cables such that the sensors located on PCB 350 can communicate with the processor provided on PCB 310. The above sensors may perform the same functionality as described above in relation to the smart socket device 100 and the smart socket device 200. In addition to the sensors shown in FIGS. 3A-3C, the safety module may further comprise any of the additional sensors or alerting functions described above in relation to the smart socket device 100 and the smart socket device 200.

Safety modules according to the present invention may be retrofitted across a plurality of conventional sockets provided within a room or building to form parts of an electrical safety system which can detect a hazard, alert a user and take appropriate action to address the hazard.

### Firefighter Helmet

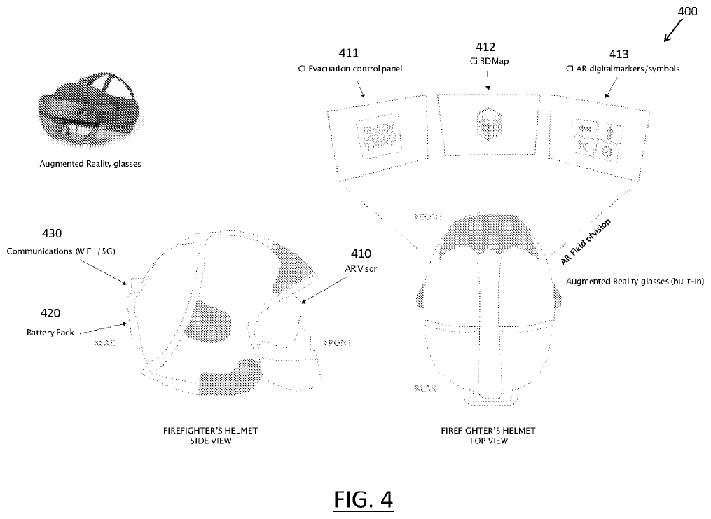

FIG. 4 schematically illustrates an exemplary firefighter's helmet 400 according to an aspect of the present invention. The helmet 400 comprises a visor 410 providing integrated augmented reality capabilities, a battery pack 420 to power the helmet and a communications link 430. The helmet 400 may optionally comprise (not shown) an integrated locationing module such as a GNSS receiver.

The augmented reality capabilities of the visor 410 enables the wearer of the helmet to display information on top of the physical world that may improve their knowledge of and efficiency when dealing with an escalated hazard such as a fire. In response to receiving a signal from a smart socket device that a hazard is present and that firefighting teams are needed, the augmented reality visor may provide the wearer with information about the current status of the hazard and real-time communications via a control panel visualisation 411. This may include for example, the type of hazard, the time at which the hazard was identified and what actions have already been taken to act on the hazard.

Furthermore a 3D mapping of the building 412 in which the hazard is located is displayed indicating whereabouts in the building the hazard is located. Further details about this 3D mapping are described below as part of an electrical safety system. The visualisation 412 may additionally allow the wearer to identify their own position within the 3D mapping and also direct the wearer towards the source of the hazard.

Additionally, a visualisation 413 may provide digital markers/symbols to the wearer to inform them, for example, of the direction they should travel in to reach the source of the hazard and of proximal blocked pathways between themselves and the source of the hazard.

### Electrical Safety System

An electrical safety system according to the present invention includes at least one smart socket device according to the present invention and may comprise a plurality of smart socket devices according to the present invention in communication with each other. The electrical safety system also includes one or more additional remote devices in communication with the at least one smart socket device via the communications link. The one or more smart socket device is configured to send a signal to the remote devices using the communications link when, for example, the processor determines that the surface temperature of the conductor of the PCB has exceeded the predetermined threshold.

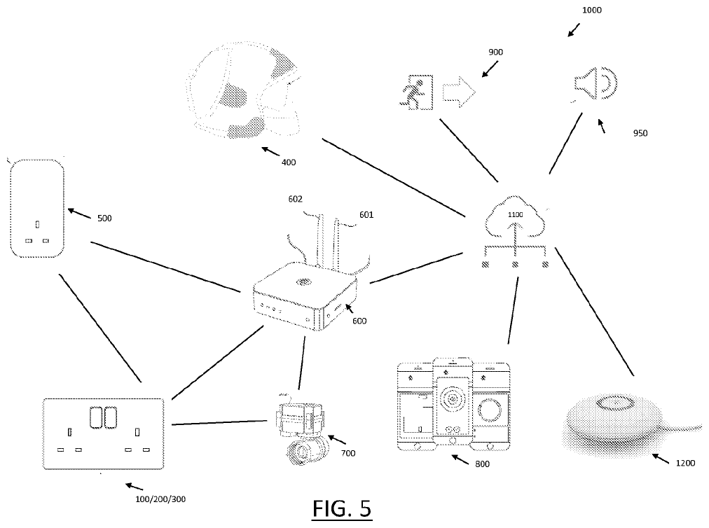

FIG. 5 illustrates an exemplary electrical safety system 1000 according to an embodiment of the present invention. The electrical safety system 1000 includes one or more smart socket devices 100/200/300, one or more smart socket devices according to the present invention embodied as plug in adapters 500, and remote devices including one or more fire safety helmets according to the present invention 400, one or more smart hubs 500, one or more smart hubs 600, one or more isolation units 700, one or more smart user devices 800, one or more dynamic signs 900, one or more speakers 950 and one or more voice assistant alarms 1200.

Devices of the electrical safety system 1000 each comprise a communications link so as to be able to communicate with each other via wireless connectivity, for radio narrow example band frequency, Wi-Fi, Bluetooth, mobile telecommunications operators network and via the OpenThread mesh networking protocol. Alternatively, or in addition to wireless communications, communication may also be performed with the use of optical or other wired communication networks, preferably ethernet or power line communication (PLC). Preferably, devices of the electrical safety system 1000 may communicate over two communication channels such that the different types of network provide a failsafe. In this example, the remote devices can communicate with each other and the smart socket devices via Wi-Fi 601 and/or a mesh network 602. The mesh network 602 may comprise a radio mesh network communicating on, for example, 868 MHz. Preferably the mesh network comprises 602 a mesh network communicating via the OpenThread mesh networking protocol. By providing two communications networks, if one network goes down, data obtained from the thermal sensors arranged throughout the building may still be communicated in order that the location of a fire hazard and the locations of the occupants of the building may be determined. In FIG. 5, lines connecting the smart socket devices 100/200/300, the smart socket devices 500, the smart hub 600 and the isolation units 700 illustrate a mesh network wherein each device can communicate with each other device independently.

The connectivity of each of the remote devices in the local network may be managed by the smart hub 600 which is connected to a central router (not shown) within the building. The smart hub 600 itself may comprise one or more thermal sensors. In preferred embodiments, the smart hub 600 is integrated within a device having further sensing capabilities. Typically, the smart hub 600 is integrated within a ceiling-mounted unit as described in United Kingdom Patent Application No. 2015243.5.

As the devices of the electrical safety system 1000 are in local communication with each other, alarms or other safety notifications may be initiated quickly in response to a detected hazard. For example, if a thermal sensor located within a smart socket device 100/200/300, 500 detects a local increase in surface temperature of the conductor of its PCB that is indicative of the presence of an electrical fault, this information may be communicated to the other safety devices within the building over the local Wi-Fi 601 and/or mesh network 602. In response, the additional smart socket devices 100/200/300, 500 provided in the electrical safety system 1000 may initiate an integrated alarm sounder to warn occupants of the fire hazard and/or switch off the power locally at the location of the smart socket device 100/200/300, 500.

An isolation unit 700 may be arranged for installation in a mains supply-for example a main water feed, a mains electricity circuit unit, a header water tank or mains gas supply. The location of an isolation unit is typically pre-configured within a building. In response to identification of a fire hazard by one or more sensors of the system, a signal may be transmitted to the isolation unit over the Wi-Fi/mesh network in order to shut off a gas, electrical or water supply to the building, significantly minimising the risk of secondary fire, explosion or electrical hazard (for example, if a major water leak impinges upon live electrical apparatus or circuitry).

The smart socket devices 100/200/300, 500 and isolation units 700 may be each assigned to a group, the grouping be based on, for example, the location of the devices, particularly in the case that electrical safety system 1000 is deployed across a multi-occupancy building. For example, electrical safety system 1000 may comprise a plurality of smart socket devices 100/200/300, 500 located across a number of flats within a building and a plurality of a mains supply isolation units 700 configured to restrict a mains supply of each flat in the building. The smart socket devices 100/200/300, 500 may be grouped based on which flat they are located in and the isolation units 700 may be grouped based on which flat's mains supplies they can restrict. If a first smart socket device 100/200/300, 500 located in a first flat determines that the sensed surface temperature of the conductor exceeds a predetermined threshold, said first smart socket device 100/200/300, 500 may use the grouping to identify which other smart socket devices 100/200/300, 500 are located within said first flat and optionally within neighbouring flats. Furthermore, the first smart socket device 100/200/300, 500 may also use the grouping to identify the one or more isolation units 700 that can restrict the mains supplies of the first flat and optionally neighbouring flats. The first smart socket device 100/200/300, 500 may then automatically send a signal to the other identified smart socket devices 100/200/300, 500 and isolation units 700 to, for example, disconnect the sockets of the smart socket devices via provided relays and/or restrict the mains supplies of one or more of gas water and electricity.

In addition to the processing performed by the smart socket devices 100/200/300, 500 of the electrical safety system 1000, data obtained by the sensors of electrical safety system 1000 may be further processed by a system processing unit 1100, which in this example is hosted remotely in a cloud system. However, in other embodiments the processing unit 1100 may be located locally within the building. Sensor data may be sent to the processing unit 1100 from the smart hub 600 over the internet via the router. In other words, the data from each sensor within the local network may be initially transmitted to the smart hub which then communicates with the processing unit. The system processor 1100 is configured to analyse the data obtained from the sensors of the electrical safety system and determine a location of a hazard or potential hazard. For example, if the data from a smart socket device located within a living room of a flat on the first floor of a building shows a local increase in temperature indicative of the presence or risk of a fire, it can be inferred that the location of the fire is within the living room of that flat. Data from the sensors of other smart sockets 100/200/300, 500 and isolation units 700 located within the flat may also be analysed in order to confirm such a conclusion.

The processing unit 1100 may be communicatively coupled to a memory, which may be a “Cloud” memory, storing, for example, information about the devices within the electrical safety system 1000 and the layout of the building in which the local devices of the electrical safety system are located. The building layout data may comprise a three dimensional (3D) mapping of locations within said building, also potentially showing the locations of smart socket devices 100/200/300, 500 and isolation units 700.

In the event of an escalated hazard such as a fire, processing unit 1100 may combine this building layout data with the location of a hazard within the mesh network identified by a smart socket device 100/200/300, 500 and the locations of further smart socket devices 100/200/300, 500 to create a 3D mapping illustrating the location of the hazard within the electrical safety system 1000. For example, If a first smart socket device 100/200/300, 500 located in a first flat of a multi-occupancy building determines that the sensed surface temperature of the conductor exceeds a predetermined threshold, said first smart socket device 100/200/300, 500 may send a signal to the processing unit 1100 of the electrical safety system 1000. The processing unit 1100 may then analyse the data sent by the first smart socket 100/200/300, 500 to determine the location of the hazard (e.g. in which flat is the hazard). The processing unit 1100 may then recall a layout of the building in which the local devices of the electrical safety system 1000 are located from the communicatively coupled memory and may then use the hazard location and building layout to generate a 3D map of the building indicating a location of the hazard. Alternatively, a 3D map of the layout of said building may be generated by processing unit 1100 based on the locations of smart socket devices 100/200/300, 500 in a mesh network within the building. In the event of an escalated hazard such as a fire, this mapping allows emergency services to act more efficiently when they arrive on the scene and occupants to evacuate safely.

Particularly advantageously, authorised users such as building managers, fire and emergency services may be able to access data sent to processing unit 1100 or stored in a communicatively coupled memory, for example by secure access to the Cloud servers so that they can see the status of the hazards real time or near-real time from their own devices. By using this information, the emergency services may focus their efforts to the particular locations of need, ensuring both the increased safety of the occupants of the building as well as the increased safety of the emergency service personnel themselves.

The data processed by processor 1100 may be communicated to one or more additional remote devices via a communications link such as the internet. A particular remote device may be a smartphone 800, a firefighter helmet 400, a dynamic sign 900, a speaker 950 and a voice assistant alarm 1200. The smartphone (or other smart user device) may run an app with which the user can receive alerts and notifications from the system processor 1100 (e.g. via a Cloud server over a communications link such as the internet) that are indicative of the location of an identified hazard, and instructions regarding what to do next. A smart user device such as a smartphone 800 or other smart device may run one or two forms of software, or “app”: (1) a user app (intended for residents), and (2) a responders app, (intended for emergency services and building authorities). The smartphone 800 may run an app (1) or (2) with which the user can manage the system and receive alerts. In particular, when a hazard is detected a signal may be sent to the smart user device from the smart socket device and the app (1) or (2) can display information on the hazard, for example that a fire has been detected, the location of the fire and provide options for the user to address the fire, for example to send a signal to isolation units 700 to shut off mains supplies.

The processing unit 1100 may receive location information from a smartphone 800, for example in order to guide a user out of the building. In some examples the system processor may also control aspects of the smartphone for example to switch on the “torch” function of the smartphone if it is detected that the mains power in the building is out.

In the event of a loss of connectivity between the communications hub and the cloud (1100), the electrical safety devices can (through WiFi or Bluetooth or other “localised” communication means, link to any smart device on which the “app” is installed, in order to provide the same functions as if the loss of connectivity to the cloud had not occurred. In this scenario, the smart device would (temporarily at least) form part of the mesh network.

The building layout data can be accessed for purposes of evacuation by the evacuees and for purposes of emergency response can be accessed by the emergency services. This data is typically stored in the cloud and accessed using appropriate user authority and identity management. This data can also be provided to, for example, local hospitals in order to notify and prepare them for an influx of possible emergency hospital admissions. This information may be accessed by active firefighters inside the building, during the fire. In this scenario, the system acts as an enhanced “spotter” to give the fire incident command, and the firefighters on the scene, the best possible picture of events with the lowest risk to themselves.

The electrical safety system comprises a communications device for communicating data to occupants of the building. This may be in form of one or more optical indicators 900 located throughout the building. For example, upon receipt of a signal from a smart socket device 100/200/300, 500, the optical indictors may be actuated in order to indicate information to the occupants of the building. The optical indicators may be in the form of dynamic signage 900 comprising a configurable display located on walls throughout the communal areas of a building. When there is no fire risk, these signs may appear blank. However, in response to a fire hazard being identified by a smart socket device 100/200/300, 500, the signs may be illuminated (e.g. by integrated LEDs) in order to exhibit status updates or instructions (e.g. in the form or arrows, symbols or text) so as to safely guide occupants out of the building.

Alternatively or in addition to the dynamic signage 900, the electrical safety system 1000 may comprise a communications device in the form of one or more speakers 950. The speakers may be configured to sound an alarm and/or an announcement in response to receiving a signal from a smart socket device 100/200/300, 500.

The dynamic signage 900 and the speakers 950 each comprise a wireless communications link for receiving a signal transmitted from the processor 1100, for example over the internet, whereby the optical indicators 900 and/or speakers 950 may be actuated.

The electrical safety system 1000 may further comprise a voice assistant alarm 1200 wherein the voice assistant alarm is configured to notify a user upon receiving a signal from a smart socket device 100/200/300, 500. The voice assistant alarm may be configured to provide one or more of: information on the type and location of the hazard, provide options for responding (e.g. call emergency services, activate an isolation device 700) or information on how to safely exit the building to avoid the hazard. The voice assistant alarm comprises a wireless communications link for receiving a signal transmitted from the processor 1100, for example over the internet.

Although it is shown in FIG. 5 that dynamic signage 900, speakers 950 and voice assistant alarm 1200 may communicate with a smart socket device 100/200/300, 500 indirectly via smart hub 600 and processor 1100, they may equally form part of the local mesh network wherein their functions may be actuated directly upon receipt of a signal from a smart socket device 100/200/300, 500 within the local mesh network.

1. A smart socket device comprising:
a socket arranged to receive an electrical plug of an electrical appliance;
a mains current connector for connection to a mains current supply cable;
a printed circuit board (PCB) comprising a conductor arranged such that current flows through the conductor between the mains current connector and the electrical plug during use;
a thermal sensor arranged to detect a change in temperature of the conductor of the PCB;
a processor in communication with the thermal sensor, the processor configured to determine when the sensed temperature of the conductor of the PCB displays behaviour indicative of a potential electrical hazard; and
a communications link configured to communicate with a remote device.

2. The smart socket device of claim 1 wherein the thermal sensor is configured to provide a contactless measurement of the temperature of the conductor of the PCB during use.

3. (canceled)

4. The smart socket device of claim 1 wherein the PCB is a first PCB and further comprising:
a second PCB comprising the thermal sensor, wherein the second PCB is arranged adjacent to the first PCB.

5. The smart socket device of claim 1 where the conductor comprises a conductive track running across a face of the PCB, wherein the thermal sensor is arranged so as to be facing the conductive track.

6. The smart socket device of claim 5:
wherein the PCB is a first PCB and the conductive track is positioned on a face of the first PCB; and further comprising:
a second PCB comprising the thermal sensor, wherein the first and second PCBs are arranged such that the thermal sensor of the second PCB faces the conductive track on the first PCB.

7. The smart socket device of claim 6 wherein the first PCB is arranged between the socket and the second PCB, the first PCB comprising a first face that faces the socket and a second, opposing, face that faces the second PCB, where the conductive track is positioned on the second face.

8. The smart socket device of claim 1 wherein the conductor comprises a connector arranged to contact a pin of the electrical plug when received in the socket.

9. The smart socket device of claim 1 wherein the socket is configured to receive a plug comprising a live pin and a neutral pin, wherein the PCB comprises:
a live conductor arranged to conduct current between a live mains wire and the live pin; and
a neutral conductor arranged to conduct current between a mains neutral wire and the neutral pin;
wherein the thermal sensor is arranged to measure the temperature of the live conductor and/or the neutral conductor.

10. The smart socket device of claim 9 comprising a first thermal sensor arranged to measure the temperature of the live conductor and a second thermal sensor arranged to measure the temperature of the neutral conductor.

11. The smart socket device of claim 1 further comprising an ambient temperature sensor configured to measure the ambient temperature in the vicinity of the smart socket device.

12. (canceled)

13. The smart socket device of claim 1 further comprising a relay configured to connect and disconnect the electrical plug from the mains current connector; wherein the processor is configured to control the relay in response to one or more of:
receiving, via the communications link, an instruction from a remote device;
the sensed temperature exceeding a threshold; or
data from a programmable timer within the smart socket device.

14. The smart socket device of claim 1 further comprising a current sensor arranged to detect the current passing through the conductor of the PCB, wherein the processor is configured to determine the presence of an electrical fault based on the combination of data received from the current sensor and data received from the thermal sensor.

15. An electrical safety system comprising:
a smart socket device according to claim 1; and
one or more remote devices;
wherein the smart socket device is configured to send a signal to the remote device using the communications link when the processor determines that the temperature of the conductor of the PCB has exceeded the predetermined threshold.

16. The electrical safety system of claim 15 wherein the electrical system comprises one or more smart socket devices and one or more remote devices, wherein the smart socket devices and remote devices form a mesh network in which the smart socket devices and remote devices can communicate.

17. (canceled)

18. The electrical safety system of claim 15 wherein at least one remote device comprises a smart user device and the smart user device is configured to provide an audio or visual alert after receiving a signal from the smart socket device.

19. The electrical safety system of claim 15 wherein at least one remote device comprises a dynamic sign comprising a configurable display, wherein the dynamic sign is configured to receive a signal from a smart socket and display information on the configurable display in response.

20. (canceled)

21. (canceled)

22. (canceled)

23. (canceled)

24. (canceled)

25. The smart socket device of claim 1 wherein the processor is configured to determine when the sensed temperature of the conductor exceeds a predetermined threshold.

26. The smart socket device of claim 4 wherein the first PCB comprises a relay for disconnecting the supply of mains power to an appliance plugged into the socket.

27. The smart socket device of claim 4 wherein the first PCB comprises a current sensor for measuring the current conducted through the conductor.

28. The smart socket device of claim 1 wherein the processor is configured to determine when the rate of change of the sensed temperature displays a particular behaviour.
